(19) United States
(12) Patent Application Publication
(10) Pub. No.: US 2001/0056365 A1
(43) Pub. Date: Dec. 27, 2001

(54) School and office product system

(76) Inventors: Yvonne M. Hutterer, Tottenham (CA); Jon R. Wyant, Centerville, OH (US); Brendan J. Boyle, Palo Alto, CA (US); Trygve A. Faste, Chicago, IL (US); Jeffery A. Grant, Menlo Park, CA (US); Tami Koenig, Tucson, AZ (US); S. Jacob Olefsky, Palo Alto, CA (US)

Correspondence Address: THOMPSON HINE L.L.P., 2000 COURTHOUSE PLAZA , N.E., 10 WEST SECOND STREET, DAYTON, OH, 45402, US

(21) Appl. No.: 09/802,601

(22) Filed: Mar. 9, 2001

Related U.S. Application Data
(60) Provisional application No. 60/187,935, filed on Mar. 9, 2000.
(60) Provisional application No. 60/196,071, filed on Apr. 10, 2000.

(51) Int. Cl. G06F 17/60

(52) U.S. Cl. 705/10

(57) ABSTRACT

A method for marketing a school and office product system including the step of packaging a school and office product with a data storage device. The data storage device includes a program which enables the user to customize or personalize the school and office product. The method further includes the step of offering the packaged product and storage device for sale as a unit. The invention also includes a method for marketing a school and office product system including the step of packaging a school and office product with a data storage device. The data storage device includes a program which can aid a user in completing school projects. The method further includes the step of offering the packaged product and storage device for sale as a unit.

This application claims priority to U.S. Provisional Application Ser. No. 60/187,935, filed Mar. 9, 2000 and U.S. Provisional Application Ser. No. 60/196,071, filed Apr. 10, 2000. The contents of both applications are hereby incorporated by reference.

The present invention relates to a school and office product system and a method for marketing and selling a school and office product system.

### BACKGROUND OF THE INVENTION

School and office products, such as binders, notebooks, portfolios, calenders, folders, folios, daily planners, tablets, book covers, and the like are widely used by students and professionals. However, many school and office products are widely available in retail stores, and therefore it may be difficult for a customer to find a unique, easily identifiable school and office product. Furthermore, it is often desirable to mark the school and office products with various indicia, such as labels, color, graphics, personal identification, etc. Accordingly, there is a need for “customizable” school and office products. There is also a need for a school and office product system that includes a binder and a data storage device that can aid a user in completing various school projects.

### SUMMARY OF THE INVENTION

The present invention includes customizable school and office products, and a method for marketing and selling customizable school and office products. The present invention is also a school and office product system that includes a school and office product and a data storage device that can aid a user in completing various school projects.

In one embodiment, the invention is a method for marketing a school and office product system including the step of packaging a school and office product with a data storage device. The data storage device includes a program which enables the user to customize or personalize the school and office product. The method further includes the step of offering the packaged school and office product and data storage device for sale as a unit.

In another embodiment, the invention is a method for marketing a school and office product system including the step of packaging a school and office product with a data storage device. The data storage device includes a program which can aid a user in completing school projects. The method further includes the step of offering the packaged school and office product and the data storage device for sale as a unit.

Other objects and advantages of the present invention will be apparent from the following description and the accompanying drawings.

### BRIEF DESCRIPTION OF THE DRAWINGS

FIG. 1 is a perspective exploded view of one embodiment of the school and office product system of the present invention;

FIG. 2 is a front view of another embodiment of the school and office product system of the present invention;

FIG. 3 is an inner view of the school and office product system of FIG. 1 or FIG. 2;

FIG. 4 is a schematic representation of a computer system using a disk of the school and office product system of FIG. 1; and

FIG. 5 is a schematic representation of one embodiment of the data and programs on the data storage device of the school and office product system of FIG. 1.

### DETAILED DESCRIPTION

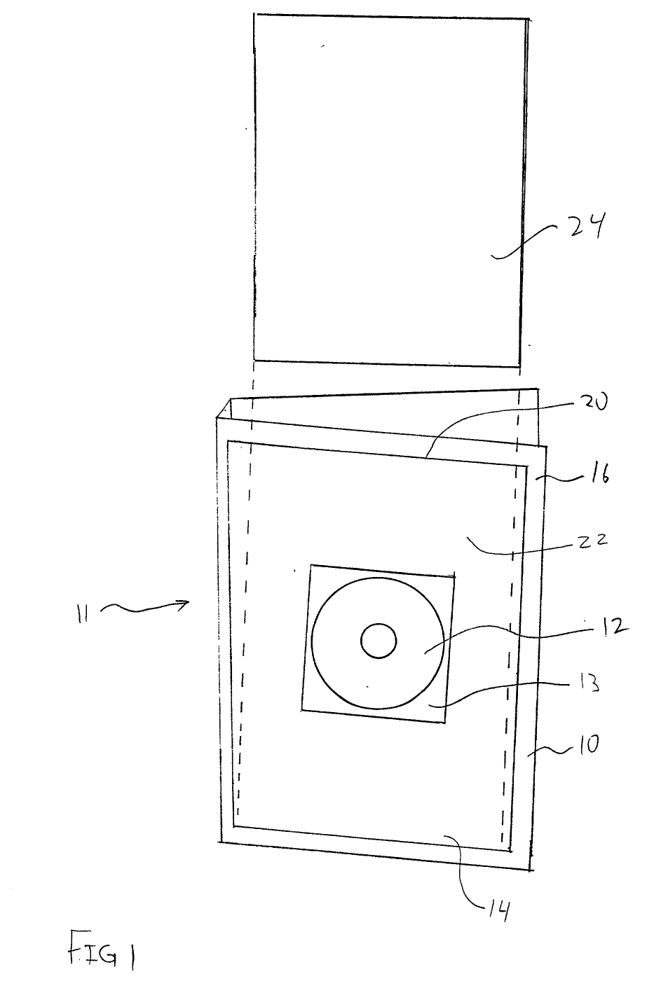

As shown in FIG. 1, in one embodiment the present invention is a school and office product system 11, and includes a school and office product such as a three-ring binder 10 and an associated data storage device or computer readable storage media, such as a compact disk 12. FIG. 1 illustrates the disk 12 inside a square packaging 13. The binder 10 and disk 12 may be packaged together for sale, or may be displayed together in a retail store. The binder 10 may include a transparent sheet of material 14, such as plastic, located on the front cover 16 of the binder 10. The sheet 14 may be attached to the cover 16 at the sides and bottom of the sheet 14, and open at its top edge 20 to form a pocket 22. The binder 10 and/or compact disk 12 may be sold with a sheet or sheets of paper, label stock, or other media that fit into the pocket 22, such as sheet 24. A sheet or sheets of the media (such as sheet 24) may be sold or packaged with the binder 10 and compact disk 12, and/or may be available for separate purchase. The pocket 22 may be sized to receive either custom-sized or standard-sized sheets of media. The compact disk 12 may include various data, programs and/or computer software, as will be discussed in detail below.

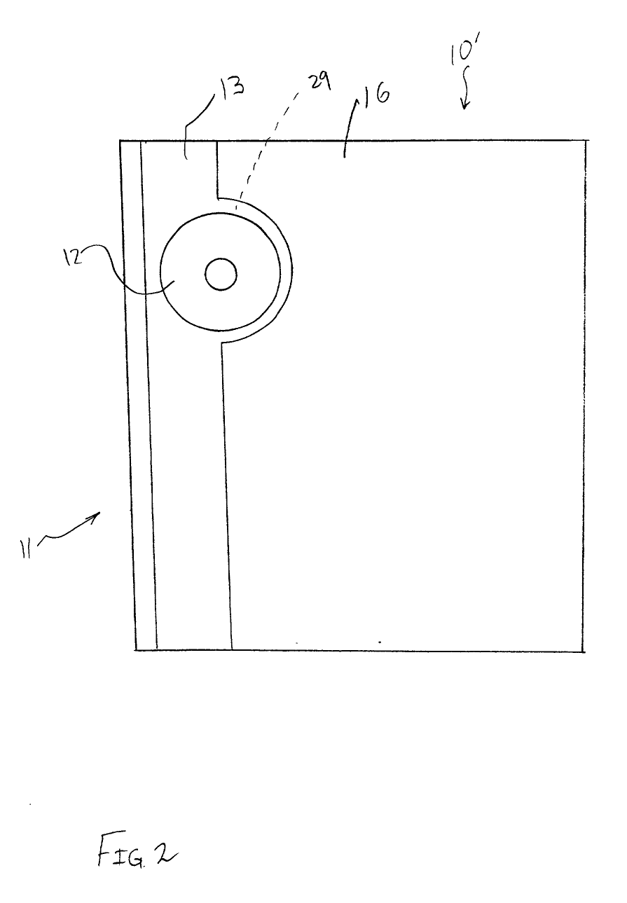

FIG. 2 illustrates an alternate embodiment of the binder wherein the binder 10 includes a sleeve 13 of packaging material that is wrapped about the front cover 16. The sleeve 13 may be made of transparent material and includes a pocket 29 formed therein for receiving the compact disk 12.

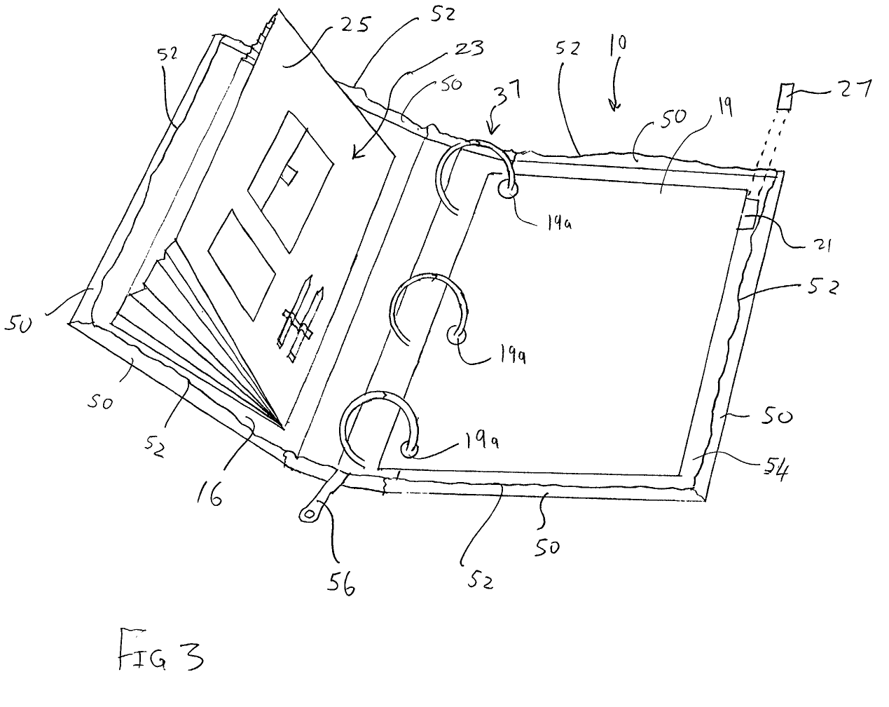

As shown in FIG. 3, the binder 10 preferably includes a binding mechanism 37 shaped to receive papers (not shown) and other media. The system 11 may include divider 19 or dividers having a set of holes 19a that correspond to the binding mechanism 37 such that the divider 19 can be mounted onto the binder 10. The divider 19 may include a pocket (not shown) which extends over a portion or the entire divider 19 and which can receive a sheet of media (not shown) having artwork or other indicia printed thereon for display. For example, the divider 19 may have a pocket similar to pocket 22 of FIG. 1. Each divider 19 may also have a transparent tab sleeve 21 for receiving an identifying index tab 27 therein.

The inner surface of the front cover 16 may include an expandable pocket 25 which may include a variety of pockets, sleeves, and the like on its outer surface 23 for receiving loose items. The binder 10 may include a gusset of material 50 extending around the outer perimeter of the binder 10. The gusset 50 may include a zippered surface (not shown) on an upper edge 52 of the gusset 50, which enables the front cover 16 and rear cover 54 to be zippered together to close the binder 10, such as by a zipper closure mechanism 56.

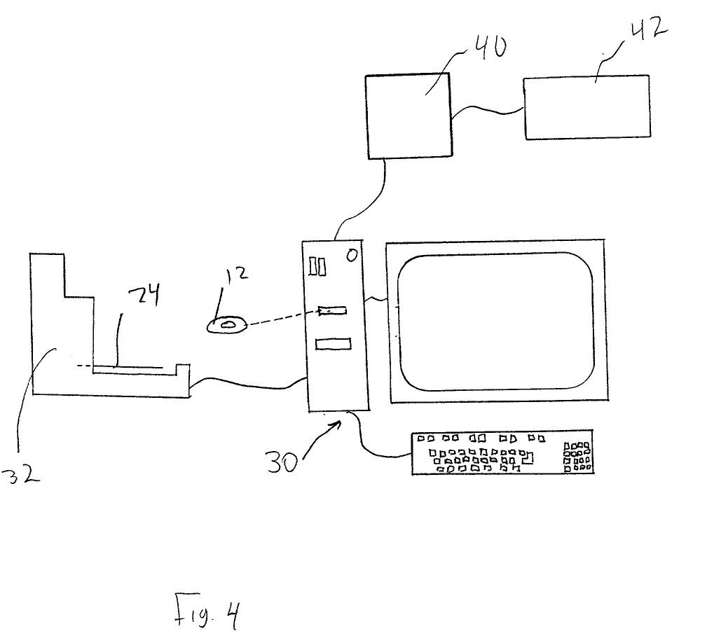

As shown in FIG. 4, after a customer or user purchases or otherwise acquires the school and office product 10 and data storage device 12, the user may load the data storage device 12 into a computer 30 to read the software, programs or data stored in the data storage device 12. As will be discussed in greater detail below, the data storage device 12 may include a variety of data, programs and/or software to assist the user in customizing the school and office product and completing various tasks and school projects. For example the data storage device 12 may include data, programs, and/or software the assist as user with his or her homework, research projects and report preparation by providing research tools, diagnostic testing programs, project tracking programs, study aids, schedulers, customizable printed art, etc.

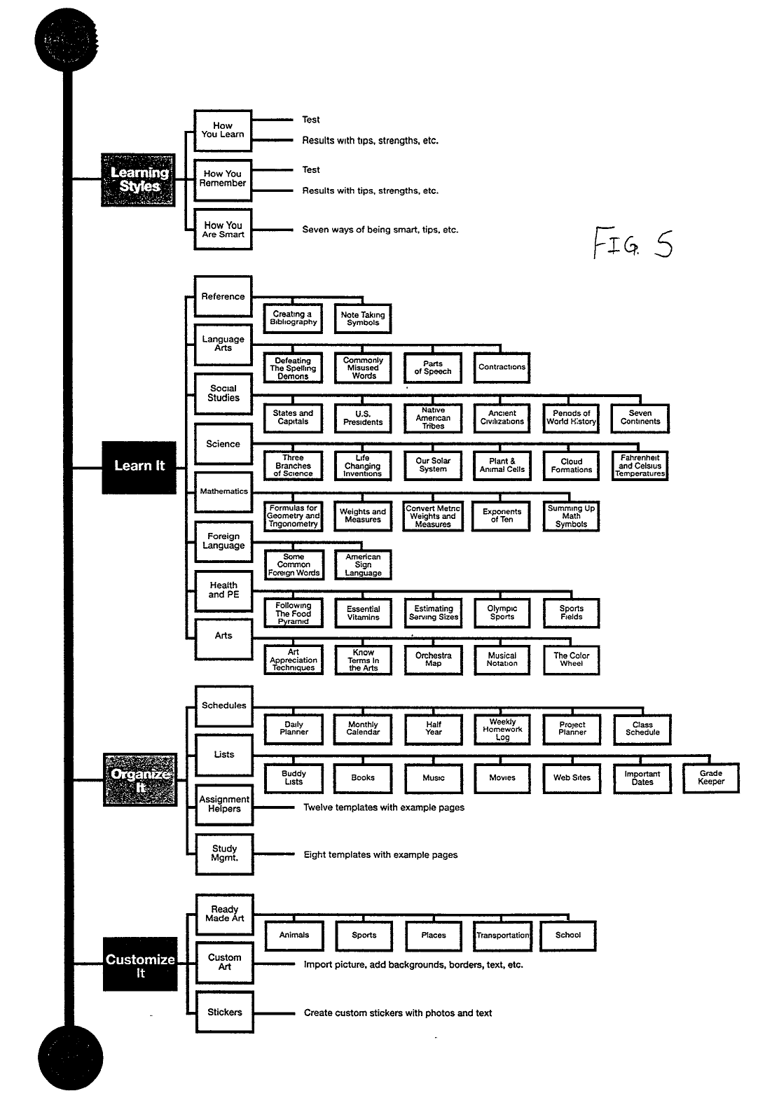

FIG. 5 illustrates an organization chart of one embodiment of the data, programs and software on the data storage device 12. In this case, the data, programs and software are divided into four categories: “Learning Styles”, “Learn It”, “Organize It” and “Customize It.” The category “Learning Styles” includes analytical programs for discerning how the user learns and remembers, and for diagnosing strengths of the student (i.e. the block labeled “How Are You Smart?”). The category “Learn It” includes a number of reference materials as disclosed in FIG. 5. The category “Organize It” includes schedulers and planners, lists, assignment helpers and study management programs. Finally, the category “Customize It” includes programs that provide ready made art, custom art and sticker programs.

The tests or diagnosis tools under the category “Learning Styles” can assist the user in understanding how he or she approaches a project (i.e. determining whether the user's thought process is “right brained” versus “left brained”; or “global” versus “analytical”; or whether the user best remembers by auditory, visual or tactile stimuli, etc.). After analyzing the test results, the program may suggest study habits which are compatible and most effective for that user's manner of thought and analysis. The program can thereby provide the user with suggestions as to how that user can most effectively and easily absorb information, take notes, and learn. After the user complete the diagnostic tests or diagnosis tools, the other programs on the data storage device may use the results of the tests to customize the other programs. For example, the programs under the category “Learn It” or “Organize It” may cause an icon to appear adjacent to a learning or planning tool that is particularly appropriate for the user based upon the results of the user's diagnostic tests.

The data storage device may also provide other useful information including references such as a dictionary, thesaurus, spell checker, calculator, and encyclopedia resources (i.e. in the category “Learn It” in FIG. 5). The data storage device may also provide one or more so-called “wizards” which provide a basic format or template for completing various school projects such as book reports, laboratory reports, etc. The data storage device may provide factual information and/or tutorials in, for example, language arts, math, social studies, science, arts, health, and foreign languages. The data storage device may also provide a list of addresses on the world wide web where the user may obtain additional information. The programs on the data storage device may provide the addresses in the form of clickable “links” or hyperlinks wherein the user can simply click on an icon an automatically be taken to the appropriate web page. The programs may also provide a brief summary of the information available at each listed web page, and which web pages may be most appropriate for each type of “learner” as identified in the diagnostic tools and programs discussed above.

The school and office product may be targeted or marketed towards a specific age group or grade level of students. In this case, the information on the data storage device, such as the reference materials, may be targeted to the subject that the students are expected to be studying at that age or grade level. Furthermore, the content of the information on the data storage device, such as the level of complexity of the reference materials, may be matched to the age and grade level of the targeted students.

The data storage device may also include various planning software and programs (i.e. under the category “Organize It” in FIG. 5). For example, the data storage device may provide schedulers, project management time lines, programs that provide daily to-do lists that help the user prioritize or print projects, or homework log sheets. When using the planning programs, the programs may enable a user to format the layout of various sheets to be used with the planning program, and then print out the sheets for use with the school and office product (i.e. print out sheets that can be received in a sized pocket of the binder 10 or in the binding mechanism 37, etc.) For example the order, arrangement, and layout of information on the sheets may be customized by the user. The user can customize the fonts and the size and location of the headings. The amount of space for making entries (i.e. the size of each “field” on the sheet such as date, activities, notes, etc.) can also be customized. Furthermore, if the user prefers a “week-at-a-time” layouts, sheets having this layout may be printed out for use with the school and office product. If, on the other hand, the user prefers a “day-at-a-time” or other layouts, sheets having the desired layout may be formatted, printed out and inserted into the school and office product.

The user may also select and print sheets for selected days or other periods of time for use with the school and office product. For example, the user may print out a new planning page every day. Alternately, the user may print a week's worth, month's worth, quarter's worth, semester's worth, or an entire year's worth of pages at any one time. Furthermore, existing information and dates (i.e. birthdays, anniversaries, known appointment etc.) may be entered into the program by the user via the supplied computer program such that the entered information is included in the printed sheets. The computer programs on the data storage device may also include schedulers, project planners and programs for printing business cards. The computer program may also provide a program for creating and maintaining lists, such as tracking a student's progress of grades in various subjects, a lists of books to be read, movies to be viewed, etc. Of course, the sheets may be sized and configured (i.e. with pre-punched holes and the like) to fit into a binding mechanism of the associated school and office product or planner.

The computer programs included in the data storage device may also be used to format and print out indicia on different type of papers or sheets for a variety of uses (i.e. under the category “Customize It” in FIG. 5). For example, the programs may be able to configure and print out accounting paper, lined paper, graph paper, problem solving tools, reference sheets (i.e. sheets having conversation tables, multiplication tables, formulas, time zones, flash cards, study sheets, area codes, maps, etc.) may be printed out for use with, or separately from, the school and office products. The user may print headings on top of the sheets in order to identify the class or project associated with the sheets.

The data storage device may also provide software for designing greeting cards or so-called “stamp art,” which is a small design which the user can select or customize and print on various documents. The data storage device may also provide software for printing out and formatting large pictures, or “ready art.” The ready art may be printed out or incorporated into reports or other documents prepared by the users. The data storage device may also include programs for listing telephone numbers, birthdays, popular movies, etc.

The computer programs and other data on the data storage may enable a user to customize various portions of the school and office product. For example the compact disk 12 of FIG. 1 may include programs that enable a user to design a cover for the binder 10. The program on the compact disk may provide and enable a user to select from an assortment of pictures, border, backgrounds, shapes, designs, patterns, colors, drawings, etc. The user may simply select or adopt the supplied pictures, designs, patterns, colors, drawings etc. “as is,” or the user may further modify or personalize the provided indicia. The user may also be able to add or incorporate personal information into the design, such as the user's name, address, grade level, information from a scanned business card, etc.

As shown in FIG. 4, the compact disk 12 associated with the binder or school and office product 10 can be loaded into a computer 30. The programs, software and data on the computer may be used to supply and enable the user to customize and format various indicia and designs. Once the user selects and formats the desired indicia and design, the indicia can be printed onto a sheet of media 24 by a printer 32 attached to the computer 30. For example, the sheet of media 24 of FIG. 4 may be sized to fit into pocket 22 of the binder 10 of FIG. 1. After the sheet 24 is printed out, the sheet 24 can slid into the pocket 22 of the binder 10, as shown in FIG. 1, to thereby customize the front cover 16 of the binder 10.

The programs on the data storage device 12 can be used to customize a wide variety of characteristics of the associated school and office product beyond the front cover. For example, when the school and office product is a binder, the binder may include a variety of pockets on it surfaces (i.e. its outer covers and spine). Pockets may also be provided on an inner surface of the binder. The pockets can be a wide variety of sizes, and papers or cards that correspond in size to the pockets may be provided with the school and office product and data storage device and/or sold separately for customization by the user. The sheets of media which can be customized by the user may include decorative features pre-printed thereon, and in this case a variety of the sheets having a variety of pre-printed designs may be provided. The media may also be an adhesive-backed media, in which case the school and office product may not necessarily require pockets and the customized adhesive backed media may be attached to the school and office product at nearly any desired location.

The programs on the data storage device may also be able to customize dividers 19 and index tabs 27 (see FIG. 3) that can be used with the binder 10 or other school and office products. In particular, in the case of index tabs, the program may provide the user with the ability to print tab index tabs 27 individually or on a sheet. Each index tab 27 may be printed on a plain or decorated background for specific subjects with respect to which the school and office products will be used. Furthermore, sheets of media that fit into other pockets (not shown) on the divider 19 may be customized using the data storage device.

In another embodiment of the invention, the school and office product or its packaging may provide a internet address or world wide web address which the user can access to use various computer programs. For example, as shown in FIG. 4 the user may be able to access the internet 40 via computer 30, and a supplier (such as a vendor of the school and office product) may maintain or provide a computer or server 42 that is accessible via the internet 40. In this case the user may be directed to access a predetermined web page and be able to access the computer programs on the server 42 through the identified web page. Alternately, the web page may enable the user to download the desired computer programs from the server 42 to the user's computer 30 via the internet 40. Of course, the internet or world wide web address may also be provided and used even when the data storage device or disk 12 is supplied to the user. In one embodiment, the user may be provided with a password or access code to enable the user to access the predetermined web page and/or download programs and data. The computer or server 42 may also be used to provide updated designs, logos, formats and the like to the user's computer 30 via the internet 40.

The school and office product 10 is preferably packaged for sale with the data storage device 12. However, the school and office product need not be packaged with the data storage device, and instead, some sort of connection between the school and office product and the data storage device may be conveyed. For example, the data storage device may be located on a retail shelf immediately adjacent to the associated school and office product, or the data storage device and the school and office product may be labeled such that a potential purchaser of said school and office product and the data storage device associates the school and office product with the data storage device. For example, the school and office product and data storage device may include a common design component, trade mark, or the like.

The system of the present invention can be used on a wide variety of school and office products, including but not limited to binders, notebooks, portfolios, calenders, folders, folios, daily planners, tablets, book covers and the like. Furthermore, a variety of computer readable media or data storage devices besides compact disks may be used, including but not limited to computer diskettes.

Having described the invention in detail and by reference to the preferred embodiments, it will be apparent that modifications and variations thereof are possible without departing from the scope of the invention.

What is claimed is:

1. A method for marketing a school and office product system comprising the steps of:
packaging a school and office product with a data storage device wherein the data storage device includes a program which enables the user to customize or personalize the school and office product; and
offering the packaged product and storage device for sale as a unit.

2. The method of claim 1 wherein said program can provide and format indicia to be printed on a sheet of media that may be mounted onto said school and office product.

3. The method of claim 2 wherein said school and office product includes a pocket for receiving said sheet of media therein, and wherein said sheet of media is sized to be received in said pocket.

4. The method of claim 3 wherein said pocket is formed by a transparent sheet of material located on and coupled to said binder.

5. The method of claim 2 wherein said packaging step includes packaging said sheet of media with said school and office product and said data storage device.

6. The method of claim 2 wherein said sheet of media includes pre-printed indicia thereon.

7. The method of claim 2 wherein said sheet of media includes an adhesive backing such that said sheet of media can be adhered to said school and office product.

8. The method of claim 2 wherein said school and office product is a binder.

9. The method of claim 8 wherein said binder includes a binding mechanism that is shaped to be coupled to said divider, and wherein said sheet of media is shaped to be received in said divider.

10. The method of claim 9 wherein said divider includes a set of holes that correspond to said binding mechanism to enable said divider to be coupled to said binder.

11. The method of claim 2 wherein said indicia to be printed on said sheet of media includes fields for dates and activities which can be formatted using said program.

12. The method of claim 11 wherein said program can process data input by a user that corresponds to a specific date and print out said date and said data that corresponds to said date on said sheet of media.

13. The method of claim 2 wherein said indicia includes colored designs.

14. The method of claim 2 wherein said indicia includes personal information.

15. The method of claim 1 wherein said data storage device is a compact disk.

16. The method of claim 1 wherein said program can be used to format and print pages having predetermined indicia thereon.

17. The method of claim 16 wherein said predetermined indicia is a set of lines such that a user can print out graph paper.

18. The method of claim 1 wherein said program includes an interactive testing tool.

19. A school and office product system comprising:
a school and office product; and
a data storage device including at least one computer readable program, said data storage device being packaged for sale with said school and office product, said computer readable program being able to provide and format indicia to be printed on a sheet of media that may be mounted onto said school and office product.

20. The system of claim 19 further comprising a sheet of media for receiving indicia thereon that is provided and formatted by said computer readable program, said sheet of media being packaged with said school and office product and said data storage device.

21. The system of claim 19 wherein said school and office product includes a pocket, and wherein said sheet of media is shaped to be closely received in said pocket.

22. A method for marketing a school and office product system comprising the steps of:
packaging a school and office product with a data storage device, wherein the data storage device includes a program which can aid a user in completing school projects; and
offering the packaged product and storage device for sale as a unit.

23. The method of claim 22 wherein said school and office product is a binder including a binding mechanism and wherein said program provides reference materials and customizable art.

24. The method of claim 23 wherein said program includes an interactive testing tool which can analyze a user's style of learning.

25. The method of claim 24 wherein said program that provides reference materials is customizable based upon the outcome of user's use of said interactive testing tool.

26. The method of claim 22 wherein said packaging step includes providing a web page address such that a purchaser of said school and office product is supplied with said web page address, and wherein said program is accessible at said web page address.

27. The method of claim 22 wherein said packaging step includes providing a web page address such that a purchaser of said school and office product is supplied with said web page address, and wherein said program can be updated when a user accesses said web page address.

28. The method of claim 22 wherein said program includes a planner, and wherein a user can input data into said planner and said planner can process said input data and match said input data with the appropriate date.

29. The method of claim 22 wherein said program includes a template for the preparation of reports.

30. A school and office product system comprising:
a school and office product; and
a data storage device packaged for sale with said school and office product, wherein the data storage device includes a program which can aid a user in completing school projects.

31. The system claim 30 wherein said school and office product is a binder including a binding mechanism and wherein said program includes an interactive testing tool which can analyze a user's style of learning.

32. The system of claim 30 wherein said data storage device includes a program that provides reference materials that can be accessed by a user.

33. The system of claim 30 wherein said data storage device includes a program that provides a personal organizer that can be used by a user to track dates and appointments, and print out sheets listing said dates and appointments.

34. The system of claim 30 wherein said data storage device includes a program that provides a customizable art that can be accessed, formatted, customized and printed out by a user using a computer.

35. The system of claim 30 wherein said program includes reference materials and said data storage device further includes an interactive testing tool which can analyze a user's style of learning, and wherein said program that includes reference materials is customizable based upon the outcome of user's use of said interactive testing tool.

36. A method for marketing a school and office product system comprising the steps of:
a seller providing a school and office product and a data storage device including at least one computer readable program;
said seller packaging said school and office product and said data storage device together for sale;
a purchaser purchasing said packaged school and office product and data storage device; and
said purchaser using said at least one computer readable program to complete a school project.

37. A method for marketing a school and office product system comprising the steps of:
providing a school and office product; and
marketing said school and office product such that a purchaser of said school and office product is supplied with a web page address, wherein when said user accesses said web page identified at said web page address said user is provided access to a program that can aid said user in completing school projects.

38. The method of claim 37 wherein when said user accesses said web page identified at said web page address said user is provided access to a program that can provide and format indicia to be printed on a sheet of media that may be mounted onto said school and office product.
